(19) United States
(12) Patent Application Publication
(10) Pub. No.: US 2009/0107300 A1
(43) Pub. Date: Apr. 30, 2009

(54) APPARATUS FOR REMOVING ROTATABLY FASTENED OBJECTS

(76) Inventor: Richard D. Cubberley, Lenoir City, TN (US)

Correspondence Address: LUEDEKA, NEELY & GRAHAM, P.C., P O BOX 1871, KNOXVILLE, TN, 37901, US

(21) Appl. No.: 11/925,135

(22) Filed: Oct. 26, 2007

(51) Int. Cl. B25B 13/02

(52) U.S. Cl. 81/119

(57) ABSTRACT

Apparatus and kit for removing rotatably fastened objects including at least one elongate member having a first end face and a second end face, such that the first end face includes a first interface to substantially engage the elongate member with a rotatably fastened object so that a rotational force is applied to the fastened object substantially when a force is applied to the elongate member, and wherein the first end face also includes a second interface to substantially engage the elongate member with a leverage tool and a second end face, and wherein the second end face includes a third interface to substantially engage the elongate member with a rotatably fastened object so that a rotational force is applied to the fastened object substantially when a force is applied to the elongate member.

### FIELD

This invention relates to the field of devices and kits for removing rotatably fastened objects.

### BACKGROUND

Devices for removing rotatable fasteners have been around for hundreds if not thousands of years, but improvements on various forms of such tools are made on a continuous basis. For example, U.S. Pat. No. 7,272,996 entitled “Spanner Socket” to James M. Pontieri describes a specific type of socket for use with hand tools such as ratchet drivers. Similarly, U.S. Pat. No. 7,270,034 entitled “Tool Kit” to Bobby Hu describes specific types of sockets and a tool kit including the sockets.

One type of device for removing rotatable fasteners includes socket wrenches. Some of these types of devices are made to be removably attached to a drive ratchet or a breaker bar along a first end, and to engage with a rotatably removable fastener along a second end. These and other similar types of devices are particularly well suited for removing rotatably fastened objects. However, a large number of socket wrenches are necessary in a given ratchet kit because each ratchet wrench only fits one specific size of rotatable fastener.

Moreover, some rotatable fasteners have unique geometries that are very specific to a type of rotatable fastener. Specific examples include clean out plugs or drain plugs. These rotatable fasteners typically have one of three geometries including a recessed square, a raised square, or a raised elongate block. Each of these specific geometries requires a different type of socket wrench for removal. Often, the correct socket wrench geometry of the correct socket wrench size is unavailable, and plugs are removed with less desirable equipment such as, for example, a hammer and a chisel. Using alternative tools often results in the destruction of the plug, damage to the surroundings, and/or injury to those working on removing the plug. For example, when a clean out plug in a building is destroyed during the process of removing the plug (or results in adjacent piping being damaged), significant flooding or other type of damage can result throughout the building. This type of situation is particularly undesirable when the flooding and/or damage occur in an upper storey of a multi-storey building.

Additionally, certain types rotatable fasteners such as, for example, clean out plugs or drain plugs are notoriously difficult to access because such plugs are often found deep within wall structures or submerged in the ground.

What is needed, therefore, is a device to minimize the drawbacks discussed above. What is also needed is a kit of devices that offers all of the most desirable tools and the proper tool sizes for removing rotatable fasteners, including kits for removing specific types of rotatable fasteners such as clean out plugs and/or drain plugs.

### SUMMARY

The above described needs are met by an apparatus for removing a rotatably fastened object that includes a multifaceted elongate member further including an elongate lateral face, a first end face, and a second end face. The first end face further includes a first interface to substantially engage the elongate member with a rotatably fastened object so that a rotational force is applied to the fastened object substantially when a force is applied to the elongate member. The first end face also includes a second interface to substantially engage the elongate member with a leverage tool. The second end face further includes a third interface to substantially engage the elongate member with a rotatably fastened object so that a rotational force is applied to the fastened object substantially when a force is applied to the elongate member. In a preferred embodiment, the second end face also includes a fourth interface to substantially engage the elongate member with a leverage tool.

In another embodiment, the first interface includes a first engagement profile and the second interface includes a second engagement profile. The first engagement profile is shaped substantially identical to the second engagement profile, but the first engagement profile and the second engagement profile are different sizes. In a related embodiment, the first engagement profile is shaped differently from the second engagement profile, but the size of the first engagement profile corresponds directly with the size if the second engagement profile.

In a particularly preferred embodiment, the elongate lateral face includes a plurality of sub-faces such that at least two of the sub-faces are substantially planar.

In a related embodiment the first interface includes a first output shape for engagement with a rotatably fastened object and the first output shape is shaped as either a recessed polygon or a raised polygon. The third interface includes a second output shape for engagement with a rotatably fastened object and the second output shape is shaped as either a recessed polygon or a raised polygon. The second interface, in contrast, includes a first input shape for engagement with a leverage tool and the first input shape is shaped in the form of a recessed polygon. In the preferred embodiment having a fourth interface, the fourth interface includes a second input shape for engagement with a leverage tool and the second input shape is shaped in the form of a recessed polygon.

Another embodiment of the invention includes a kit that includes at least two apparatus for removing rotatably fastened objects. The two apparatus include a first elongate member and a second elongate member. The first elongate member includes a first lateral face, a first end face, and a second end face. The first end face includes a first interface to substantially engage the first elongate member with a rotatably fastened object so that a rotational force is applied to the fastened object substantially when a force is applied to the first elongate member. The first end face further includes a second interface to substantially engage the first elongate member with a leverage tool. The second end face includes a third interface to substantially engage the first elongate member with a rotatably fastened object so that a rotational force is applied to the fastened object substantially when a force is applied to the first elongate member. In a preferred embodiment, the second end face further includes a fourth interface to substantially engage the first elongate member with a leverage tool. The second elongate member includes a second lateral face, a third end face, and a fourth end face. The third end face includes a fifth interface to substantially engage the second elongate member with a rotatably fastened object so that a rotational force is applied to the fastened object substantially when a force is applied to the second elongate member. The fourth end face includes a sixth interface to substantially engage the second elongate member with a leverage tool.

Although some of the more basic embodiments of the invention are described in the summary above, other important preferred embodiments and alternative embodiments will become apparent with further reference to specification and the associated figures.

### BRIEF DESCRIPTION OF THE DRAWINGS

Further advantages of the invention are apparent by reference to the detailed description in conjunction with the figures, wherein elements are not to scale so as to more clearly show the details, wherein like reference numbers indicate like elements throughout the several views, and wherein:

FIG. 1 depicts a dual perspective view from both ends of a first embodiment of an apparatus for removing a rotatably fastened object, the apparatus including an octagonal lateral configuration;

FIG. 2 depicts a dual perspective view from both ends of a second embodiment of an apparatus for removing a rotatably fastened object, the apparatus including a rounded lateral configuration;

FIG. 3 depicts a dual perspective view from both ends of a third embodiment of an apparatus for removing a rotatably fastened object, the apparatus including an octagonal lateral configuration;

FIG. 4A depicts a dual perspective view from both ends of a fourth embodiment of an apparatus for removing a rotatably fastened object, the apparatus including a partially rounded lateral configuration with at least two sub-faces that are substantially planar;

FIG. 4B shows an end view of the apparatus displayed in FIG. 4A, giving a better view of the profile of the lateral surface of the apparatus.

FIG. 5 depicts a dual perspective view from both ends of a fifth embodiment of an apparatus for removing a rotatably fastened object, the apparatus including a triangular lateral configuration;

FIG. 6 depicts a side view of a sixth embodiment of an apparatus for removing a rotatably fastened object;

FIG. 7 depicts a side view of a seventh embodiment of an apparatus for removing a rotatably fastened object;

FIG. 8 depicts a side view of an eighth embodiment of an apparatus for removing a rotatably fastened object;

FIG. 9 depicts a dual perspective view from both ends of a ninth embodiment of an apparatus for removing a rotatably fastened object;

FIG. 10 depicts a side view of the apparatus shown in FIG. 9.

FIG. 11 depicts a perspective view of a tenth embodiment of an apparatus for removing a rotatably fastened object, the apparatus including a hexagonal input shape;

FIG. 12 depicts a perspective view of a tenth embodiment of an apparatus for removing a rotatably fastened object, the apparatus including a hexagonal output shape;

FIG. 13 depicts a dual perspective view from both ends of a first embodiment of kit of apparatus for removing rotatably fastened objects;

FIG. 14 depicts a dual perspective view from both ends of a second embodiment of kit of apparatus for removing rotatably fastened objects; and

FIG. 15 depicts a dual perspective view from both ends of a third embodiment of kit of apparatus for removing rotatably fastened objects.

### DETAILED DESCRIPTION

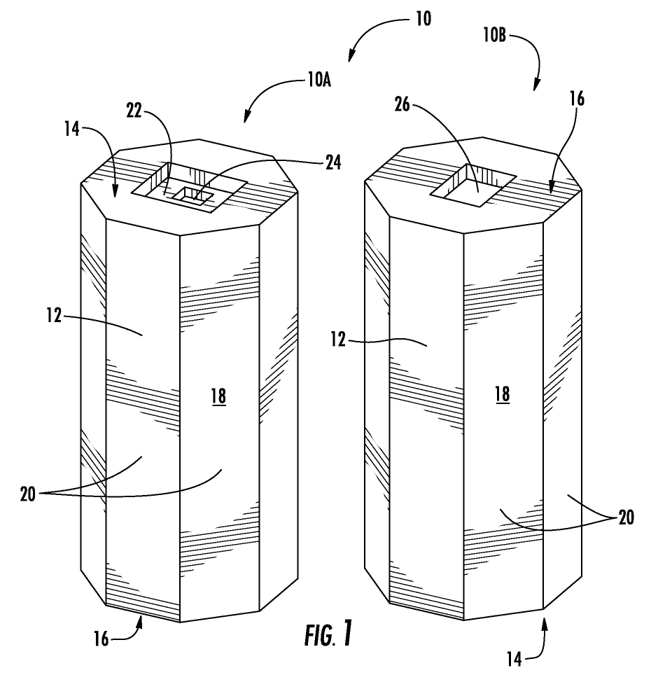

FIG. 1 shows an embodiment of an apparatus 10 for removing a rotatably fastened object. The apparatus 10 shown in FIG. 1 is in the form of a socket. The apparatus 10 further includes an elongate member 12, a first end face 14, and a second end face 16. The elongate member 12 further includes a lateral face 18 that, in this embodiment, is further subdivided into eight sub-faces 20. FIG. 1 shows a dual view of the apparatus 10 with a first view 10A showing the first end face 14 on top and a second view 10B showing the second end face 16 on top.

As shown by view 10A, the first end face 14 includes a first interface 22 that is shaped to fit with a particular type of rotatably fastened object. In the particular embodiment shown in FIG. 1, the first interface 22 is shaped in the form of a recessed square. Although a recessed square shape is used in this particular exemplary embodiment, the various embodiments of the invention described herein are not meant to be limited to any particular output shape and may include, for example, six point, eight point, and even twelve point output interface configurations. The first interface 22 is particularly well suited to engage with certain types of drain plugs and clean out plugs. The first end face 14 also includes a second interface 24 for removable engagement with a leverage member such as, for example, a ratcheting socket wrench, a flex handle, and/or a breaker bar. In the particular embodiment shown in FIG. 1, the second interface 24 is shaped in the form of a recessed square. However, any shape for engaging a socket to a leverage member (such as, for example, a ratcheting socket wrench, a flex handle, and/or a breaker bar) known to a person having ordinary skill in the art may be used. Interfaces such as interface 24 are sometimes referred to as “drives” and typically come in sizes including ¼ inch, ⅜ inch, ½ inch, and ¾ inch, although the various embodiments described herein are not meant to be limited by any particular drive size. Moreover, any mechanism known to a person having ordinary skill in the art for more securely engaging a socket to a leverage member may be included along or within the second interface 24 such as, for example, a retractable locking pin.

As shown by view 10B, the second end face 14 includes a third interface 26 that is shaped to fit with a particular type of rotatably fastened object. In the embodiment shown in FIG. 1, the third interface 26 is substantially the same recessed shape as the first interface 22, but the third interface 26 is smaller so that the third interface 26 is capable of engagement with a different sized rotatably fastened object. As with the first interface 22, the third interface 26 is particularly well suited to engage with certain types of drain plugs and clean out plugs.

The dual end structure of the socket 10 having two interfaces (i.e., the first interface 22 and the third interface 26) for engaging two different sized rotatably fastened objects minimizes the total number of sockets that are necessary in a kit of related sockets. Additionally, the lateral face 18 with its plurality of substantially flat sub-faces 20 allows for the socket 10 to be engaged along the lateral face 18 by, for example, a human hand, a wrench, or pliers.

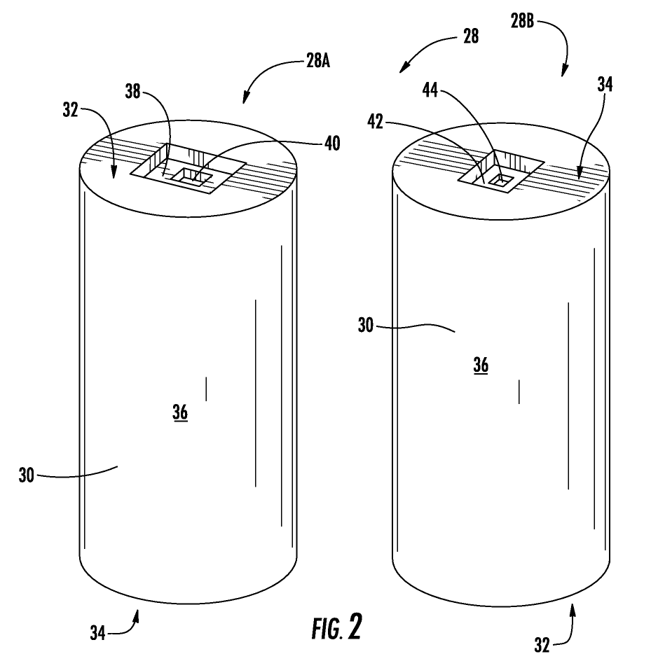

FIG. 2 shows a related embodiment of an apparatus 28 for removing a rotatably fastened object. The apparatus 28 shown in FIG. 2 is also in the form of a socket. The apparatus 28 further includes an elongate member 30, a first end face 32, and a second end face 34. The elongate member 30 further includes a lateral face 36 that, in this embodiment. FIG. 2 shows a dual view of the apparatus 28 with a first view 28A showing the first end face 32 on top and a second view 28B showing the second end face 34 on top.

As shown by view 28A, the first end face 32 includes a first interface 38 that is shaped to fit with a particular type of rotatably fastened object. In the particular embodiment shown in FIG. 2, the first interface 38 is shaped in the form of a recessed square. The first interface 38 is particularly well suited to engage with certain types of drain plugs and clean out plugs. The first end face 32 also includes a second interface 40 for removable engagement with a leverage member such as, for example, a ratcheting socket wrench, a flex handle, and/or a breaker bar. In the particular embodiment shown in FIG. 2, the second interface 40 is shaped in the form of a recessed square. However, any shape for engaging a socket to a leverage member known to persons having ordinary skill in the art may be used. Moreover, any mechanism known to persons having skill in the art for more securely engaging a socket to a leverage member may be included along or within the second interface 40.

As shown by view 28B, the second end face 34 includes a third interface 42 that is shaped to fit with a particular type of rotatably fastened object. In the embodiment shown in FIG. 2, the third interface 42 is substantially the same recessed shape as the first interface 38, but the third interface 42 is smaller so that the third interface 42 is capable of engagement with a different sized rotatably fastened object. As with the first interface 38, the third interface 42 is particularly well suited to engage with certain types of drain plugs and clean out plugs. The second end face 34 also includes a fourth interface 44 for removable engagement with a leverage member such as, for example, a ratcheting socket wrench, a flex handle, and/or a breaker bar. In the particular embodiment shown in FIG. 2, the fourth interface 44 is shaped in the form of a recessed square, and is preferably substantially identical to the second interface 40.

The dual end structure of the socket 28 having two output interfaces (i.e., the first interface 38 and the third interface 42) for engaging two different sized rotatably fastened objects and two input interfaces (i.e., the second interface 40 and the fourth interface 44) for engaging the socket 28 with a leverage member minimizes the total number of sockets that are necessary in a kit of related sockets.

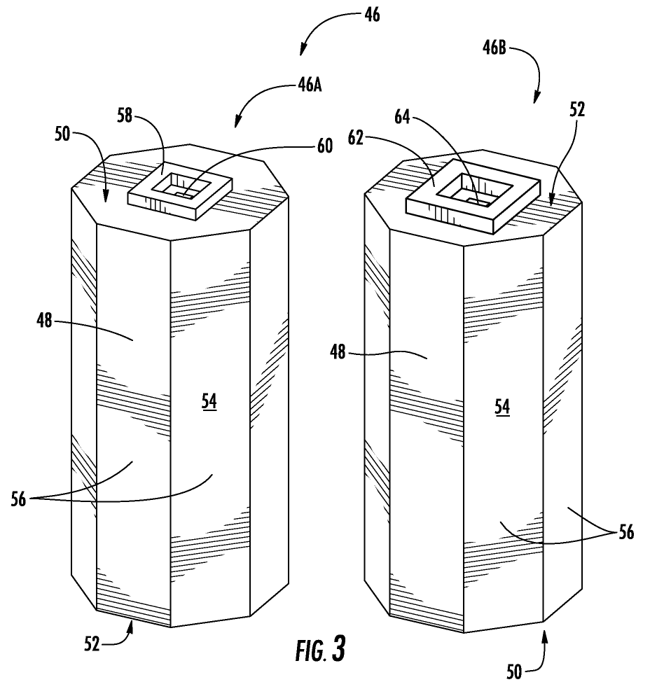

FIG. 3 shows an embodiment an apparatus 46 for removing a rotatably fastened object that is similar to the embodiment described above with reference to FIG. 1. The apparatus 46 shown in FIG. 3 is in the form of a socket. The apparatus 46 further includes an elongate member 48, a first end face 50, and a second end face 52. The elongate member 48 further includes a lateral face 54 that, in this embodiment, is further subdivided into eight sub-faces 56. FIG. 3 shows a dual view of the apparatus 46 with a first view 46A showing the first end face 50 on top and a second view 46B showing the second end face 52 on top.

As shown by view 46A, the first end face 50 includes a first interface 58 that is shaped to fit with a particular type of rotatably fastened object. In the particular embodiment shown in FIG. 3, the first interface 58 is shaped in the form of a raised square. The first interface 58 is particularly well suited to engage with certain types of drain plugs and clean out plugs. The first end face 50 also includes a second interface 60 for removable engagement with a leverage member such as, for example, a ratcheting socket wrench, a flex handle, and/or a breaker bar. In the particular embodiment shown in FIG. 3, the second interface 60 is shaped in the form of a recessed square. However, any shape for engaging a socket to a leverage member known to persons having ordinary skill in the art may be used. Moreover, any mechanism known to persons having ordinary skill in the art for more securely engaging a socket to a leverage member may be included along or within the second interface 60.

As shown by view 46B, the second end face 52 includes a third interface 62 that is shaped to fit with a particular type of rotatably fastened object. In the embodiment shown in FIG. 3, the third interface 62 is substantially the same raised shape as the first interface 58, but the third interface 62 is larger so that the third interface 62 is capable of engagement with a different sized rotatably fastened object. As with the first interface 58, the third interface 62 is particularly well suited to engage with certain types of drain plugs and clean out plugs. The second end face 52 also includes a fourth interface 64 for removable engagement with a leverage member such as, for example, a ratcheting socket wrench, a flex handle, and/or a breaker bar. In the particular embodiment shown in FIG. 3, the fourth interface 64 is shaped in the form of a recessed square, and is preferably substantially identical to the second interface 60.

The dual end structure of the socket 46 having two output interfaces (i.e., the first interface 58 and the third interface 62) for engaging two different sized rotatably fastened objects and two input interfaces (i.e., the second interface 60 and the fourth interface 64) for engaging the socket 46 with a leverage member minimizes the total number of sockets that are necessary in a kit of related sockets. Additionally, the lateral face 54 with its plurality of substantially flat sub-faces 56 allows for the socket 46 to be engaged along the lateral face 18 by, for example, a human hand, a wrench, or pliers.

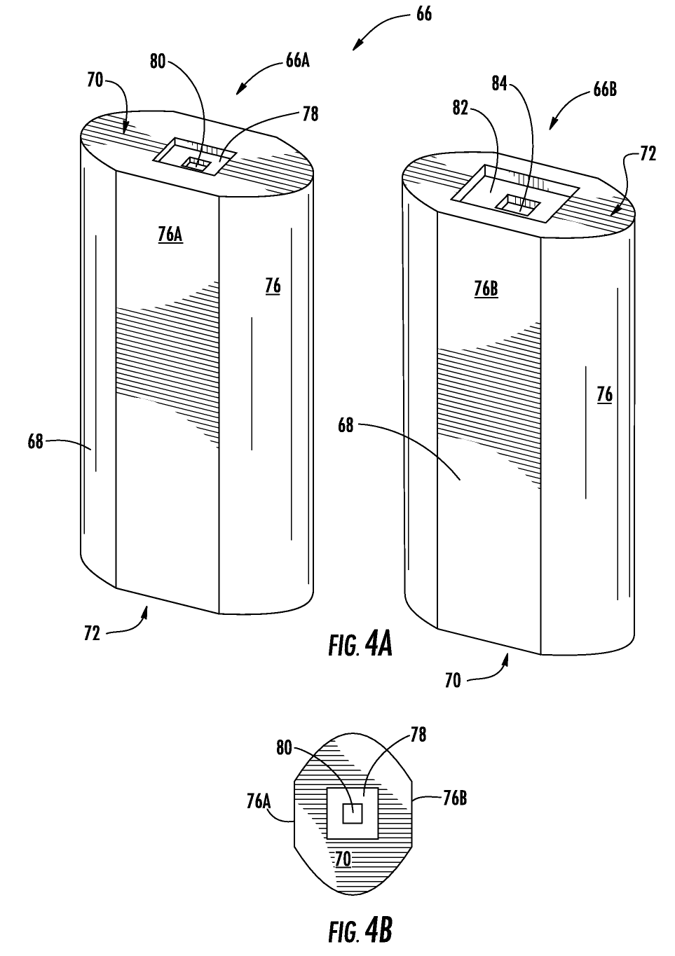

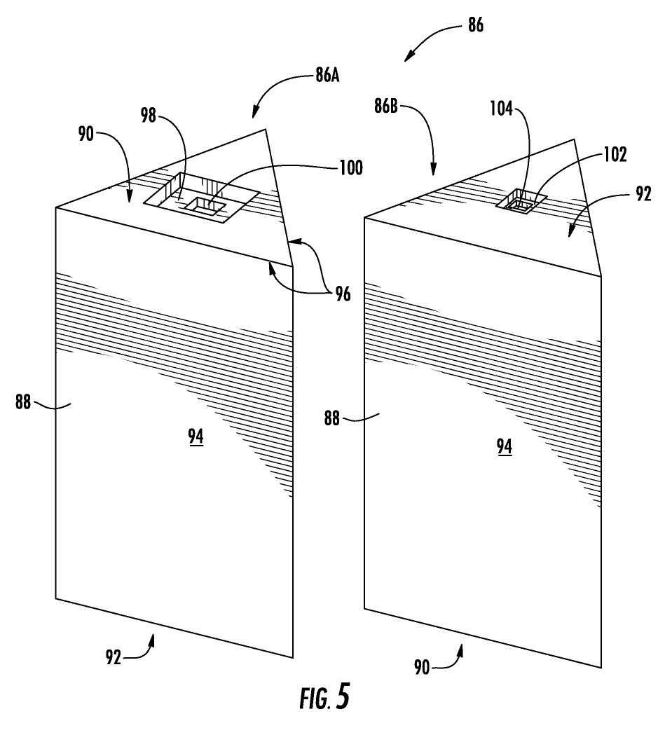

FIG. 4A and FIG. 4B show an embodiment an apparatus 66 for removing a rotatably fastened object. The apparatus 66 further includes an elongate member 68, a first end face 70, and a second end face 72. The elongate member 68 further includes a lateral face 74 that, in this embodiment, is further subdivided into a plurality of sub-faces 76 including two substantially planar sub-faces (76A and 76B). FIG. 4A shows a dual view of the apparatus 66 with a first view 66A showing the first end face 70 on top and a second view 66B showing the second end face 72 on top.

As shown by view 66A, the first end face 70 includes a first interface 78 that is shaped to fit with a particular type of rotatably fastened object. In the particular embodiment shown in FIG. 4A and FIG. 4B, the first interface 78 is shaped in the form of a recessed square. The first interface 78 is particularly well suited to engage with certain types of drain plugs and clean out plugs. The first end face 70 also includes a second interface 80 for removable engagement with a leverage member such as, for example, a ratcheting socket wrench, a flex bar, and/or a breaker bar. In the particular embodiment shown in FIG. 4A and FIG. 4B, the second interface 80 is shaped in the form of a recessed square. However, any shape for engaging a socket to a leverage member known to persons having ordinary skill in the art may be used. Moreover, any mechanism known to persons having ordinary skill in the art for more securely engaging a socket to a leverage member may be included along or within the second interface 80.

As shown by view 66B, the second end face 72 includes a third interface 82 that is shaped to fit with a particular type of rotatably fastened object. In the embodiment shown in FIG. 4A, the third interface 82 is substantially the same recessed shape as the first interface 78, but the third interface 82 is larger so that the third interface 82 is capable of engagement with a different sized rotatably fastened object. As with the first interface 78, the third interface 82 is particularly well suited to engage with certain types of drain plugs and clean out plugs. The second end face 72 also includes a fourth interface 84 for removable engagement with a leverage member such as, for example, a ratcheting socket wrench, a flex bar, and/or a breaker bar. In the particular embodiment shown in FIG. 4A, the fourth interface 84 is shaped in the form of a recessed square, and is preferably substantially identical to the second interface 80.

The dual end structure of the apparatus 66 having two output interfaces (i.e., the first interface 78 and the third interface 82) for engaging two different sized rotatably fastened objects and two input interfaces (i.e., the second interface 80 and the fourth interface 84) for engaging the apparatus 66 with a leverage member minimizes the total number of apparatus that are necessary in a kit of related tools. Additionally, the lateral face 74 with its plurality of substantially flat sub-faces 76 allows for the apparatus 66 to be engaged along the lateral face 74 by, for example, a human hand, a wrench, or pliers.

FIG. 5 demonstrates yet another embodiment of an apparatus 86 for removing a rotatably fastened object. The apparatus 86 further includes an elongate member 88, a first end face 90, and a second end face 92. The elongate member 88 further includes a lateral face 94 that, in this embodiment, is further subdivided into a three sub-faces 96. FIG. 5 shows a dual view of the apparatus 86 with a first view 86A showing the first end face 90 on top and a second view 86B showing the second end face 92 on top.

As shown by view 86A, the first end face 90 includes a first interface 98 that is shaped to fit with a particular type of rotatably fastened object. In the particular embodiment shown in FIG. 5, the first interface 98 is shaped in the form of a recessed square. The first interface 98 is particularly well suited to engage with certain types of drain plugs and clean out plugs. The first end face 90 also includes a second interface 100 for removable engagement with a leverage member such as, for example, a ratcheting socket wrench, a flex handle, and/or a breaker bar. In the particular embodiment shown in FIG. 5, the second interface 100 is shaped in the form of a recessed square. However, any shape for engaging a socket to a leverage member known to persons having ordinary skill in the art may be used. Moreover, any mechanism known to persons having ordinary skill in the art for more securely engaging a socket to a leverage member may be included along or within the second interface 100.

As shown by view 86B, the second end face 92 includes a third interface 102 that is shaped to fit with a particular type of rotatably fastened object. In the embodiment shown in FIG. 5, the third interface 102 is substantially the same recessed shape as the first interface 98, but the third interface 102 is smaller so that the third interface 102 is capable of engagement with a different sized rotatably fastened object. As with the first interface 98, the third interface 102 is particularly well suited to engage with certain types of drain plugs and clean out plugs. The second end face 92 also includes a fourth interface 104 for removable engagement with a leverage member such as, for example, a ratchet or a breaker bar. In the particular embodiment shown in FIG. 5, the fourth interface 104 is shaped in the form of a recessed square, and is preferably substantially identical to the second interface 100.

The dual end structure of the apparatus 86 having two output interfaces (i.e., the first interface 98 and the third interface 102) for engaging two different sized rotatably fastened objects and two input interfaces (i.e., the second interface 100 and the fourth interface 104) for engaging the apparatus 86 with a leverage member minimizes the total number of apparatus that are necessary in a kit of related tools. Additionally, the lateral face 94 with its three sub-faces 96 allows for the apparatus 86 to be engaged along the lateral face 94 by, for example, a human hand, a wrench, or pliers.

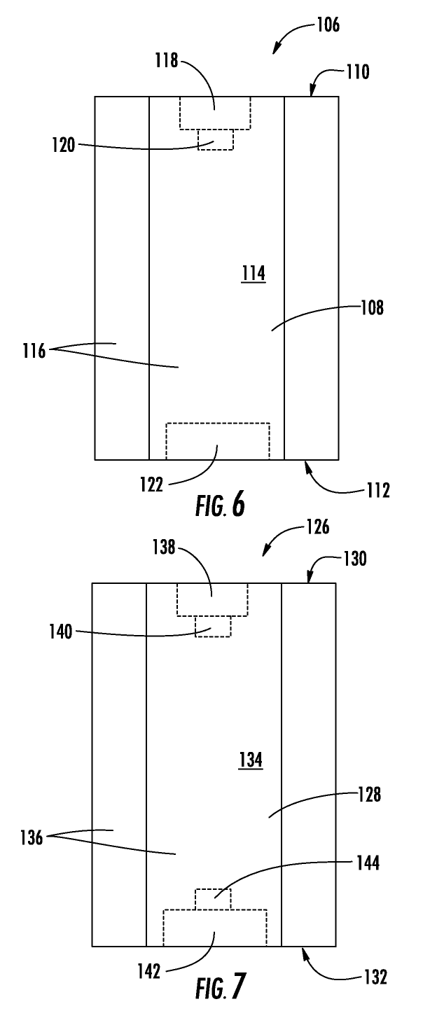

FIG. 6 shows a side view of an embodiment of an apparatus 106 for removing a rotatably fastened object. The apparatus 106 further includes an elongate member 108, a first end face 110, and a second end face 112. The elongate member 108 further includes a lateral face 114 that, in this embodiment, is further subdivided into a plurality of sub-faces 116.

The first end face 110 includes a first interface 118 that is shaped to fit with a particular type of rotatably fastened object. In the particular embodiment shown in FIG. 6, the first interface 118 is shaped in the form of a recessed square. The first interface 118 is particularly well suited to engage with certain types of drain plugs and clean out plugs. The first end face 110 also includes a second interface 120 for removable engagement with a leverage member such as, for example, a ratcheting socket wrench, a flex bar, and/or a breaker bar. In the particular embodiment shown in FIG. 6, the second interface 120 is shaped in the form of a recessed square. However, any shape for engaging a socket to a leverage member known to persons having ordinary skill in the art may be used. Moreover, any mechanism known to persons having ordinary skill in the art for more securely engaging a socket to a leverage member may be included along or within the second interface 120.

The second end face 112 includes a third interface 122 that is shaped to fit with a particular type of rotatably fastened object. In the embodiment shown in FIG. 6, the third interface 122 is substantially the same recessed shape as the first interface 118, but the third interface 122 is larger so that the third interface 122 is capable of engagement with a different sized rotatably fastened object. As with the first interface 118, the third interface 122 is particularly well suited to engage with certain types of drain plugs and clean out plugs.

The dual end structure of the apparatus 106 having two output interfaces (i.e., the first interface 98 and the third interface 102) for engaging two different sized rotatably fastened objects minimizes the total number of apparatus that are necessary in a kit of related tools. Additionally, the lateral face 114 with its plurality of sub-faces 116 allows for the apparatus 106 to be engaged along the lateral face 104 by, for example, a human hand, a wrench, or pliers.

FIG. 7 shows a side view of another embodiment of an apparatus 126 for removing a rotatably fastened object. The apparatus 126 further includes an elongate member 128, a first end face 130, and a second end face 132. The elongate member 128 further includes a lateral face 134 that, in this embodiment, is further subdivided into a plurality of sub-faces 136.

The first end face 130 includes a first interface 138 that is shaped to fit with a particular type of rotatably fastened object. In the particular embodiment shown in FIG. 7, the first interface 138 is shaped in the form of a recessed square. The first interface 138 is particularly well suited to engage with certain types of drain plugs and clean out plugs. The first end face 130 also includes a second interface 140 for removable engagement with a leverage member such as, for example, a ratcheting socket wrench, a flex bar, and/or a breaker bar. In the particular embodiment shown in FIG. 7, the second interface 140 is shaped in the form of a recessed square. However, any shape for engaging a socket to a leverage member known to persons having ordinary skill in the art may be used. Moreover, any mechanism known to persons having ordinary skill in the art for more securely engaging a socket to a leverage member may be included along or within the second interface 140.

The second end face 132 includes a third interface 142 that is shaped to fit with a particular type of rotatably fastened object. In the embodiment shown in FIG. 7, the third interface 142 is substantially the same recessed shape as the first interface 138, but the third interface 142 is larger so that the third interface 142 is capable of engagement with a different sized rotatably fastened object. As with the first interface 138, the third interface 142 is particularly well suited to engage with certain types of drain plugs and clean out plugs. The second end face 132 also includes a fourth interface 144 for removable engagement with a leverage member such as, for example, a ratchet or a breaker bar. In the particular embodiment shown in FIG. 7, the fourth interface 144 is shaped in the form of a recessed square, and is preferably substantially identical to the second interface 140.

The dual end structure of the apparatus 126 having two output interfaces (i.e., the first interface 138 and the third interface 142) for engaging two different sized rotatably fastened objects and two input interfaces (i.e., the second interface 140 and the fourth interface 144) for engaging the apparatus 126 with a leverage member minimizes the total number of apparatus that are necessary in a kit of related tools. Additionally, the lateral face 134 with its plurality of sub-faces 136 allows for the apparatus 126 to be engaged along the lateral face 134 by, for example, a human hand, a wrench, or pliers.

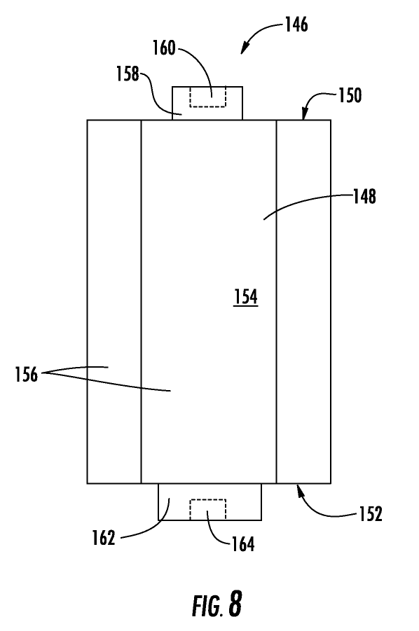

FIG. 8 shows a side view of yet another embodiment of an apparatus 146 for removing a rotatably fastened object. The apparatus 146 further includes an elongate member 148, a first end face 150, and a second end face 152. The elongate member 148 further includes a lateral face 154 that, in this embodiment, is further subdivided into a plurality of sub-faces 156.

The first end face 150 includes a first interface 158 that is shaped to fit with a particular type of rotatably fastened object. In the particular embodiment shown in FIG. 8, the first interface 158 is shaped in the form of a raised square. The first interface 158 is particularly well suited to engage with certain types of drain plugs and clean out plugs. The first end face 150 also includes a second interface 160 for removable engagement with a leverage member such as, for example, a ratcheting socket wrench, a flex bar, and/or a breaker bar. In the particular embodiment shown in FIG. 8, the second interface 160 is shaped in the form of a recessed square. However, any shape for engaging a socket to a leverage member known to persons having ordinary skill in the art may be used. Moreover, any mechanism known to persons having ordinary skill in the art for more securely engaging a socket to a leverage member may be included along or within the second interface 160.

The second end face 152 includes a third interface 162 that is shaped to fit with a particular type of rotatably fastened object. In the embodiment shown in FIG. 8, the third interface 162 is substantially the same raised shape as the first interface 158, but the third interface 142 is larger so that the third interface 142 is capable of engagement with a different sized rotatably fastened object. As with the first interface 158, the third interface 162 is particularly well suited to engage with certain types of drain plugs and clean out plugs. The second end face 152 also includes a fourth interface 164 for removable engagement with a leverage member such as, for example, a ratchet or a breaker bar. In the particular embodiment shown in FIG. 8, the fourth interface 164 is shaped in the form of a recessed square, and is preferably substantially identical to the second interface 160.

The dual end structure of the apparatus 146 having two output interfaces (i.e., the first interface 158 and the third interface 162) for engaging two different sized rotatably fastened objects and two input interfaces (i.e., the second interface 160 and the fourth interface 164) for engaging the apparatus 146 with a leverage member minimizes the total number of apparatus that are necessary in a kit of related tools. Additionally, the lateral face 154 with its plurality of sub-faces 156 allows for the apparatus 146 to be engaged along the lateral face 154 by, for example, a human hand, a wrench, or pliers.

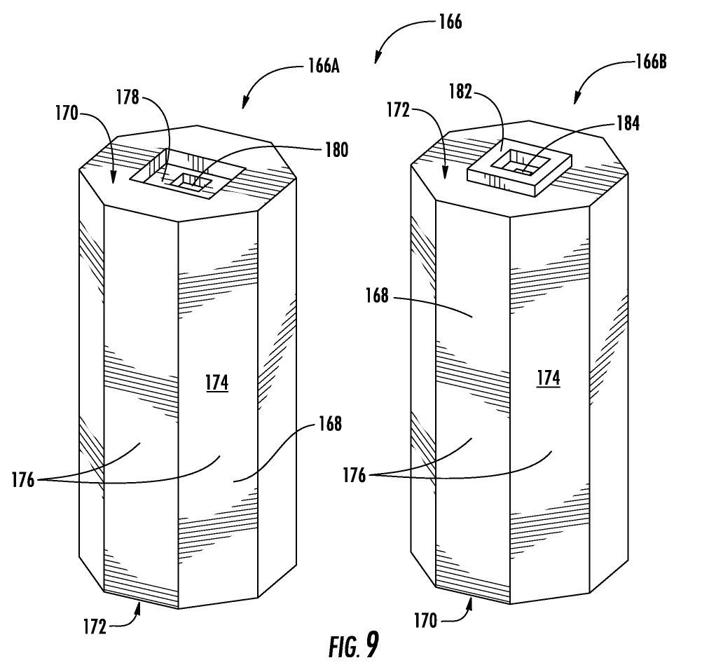

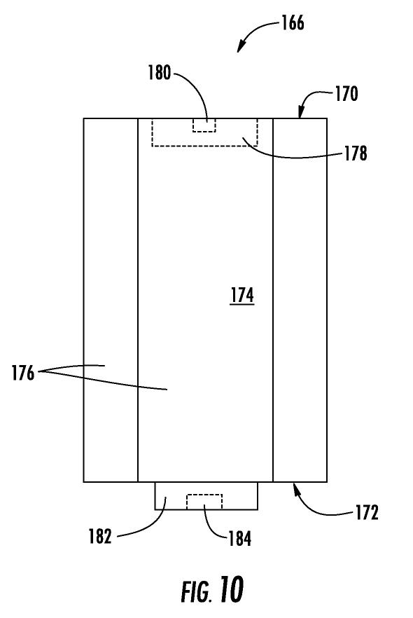

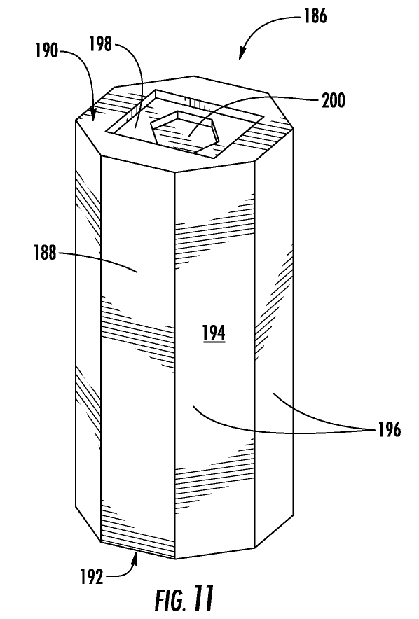

FIG. 9 and FIG. 10 show another embodiment of an apparatus 166 for removing a rotatably fastened object. The apparatus 166 further includes an elongate member 168, a first end face 170, and a second end face 172. The elongate member 168 further includes a lateral face 174 that, in this embodiment, is further subdivided into a plurality of sub-faces 176. FIG. 9 shows a dual view of the apparatus 166 with a first view 166A showing the first end face 170 on top and a second view 166B showing the second end face 172 on top.

The first end face 170 includes a first interface 178 that is shaped to fit with a particular type of rotatably fastened object. In the particular embodiment shown in FIG. 9 and FIG. 10, the first interface 178 is shaped in the form of a recessed square. The first interface 178 is particularly well suited to engage with certain types of drain plugs and clean out plugs. The first end face 170 also includes a second interface 180 for removable engagement with a leverage member such as, for example, a ratcheting socket wrench, a flex bar, and/or a breaker bar. In the particular embodiment shown in FIG. 9 and FIG. 10, the second interface 180 is shaped in the form of a recessed square. However, any shape for engaging a socket to a leverage member known to persons having ordinary skill in the art may be used. Moreover, any mechanism known to persons having ordinary skill in the art for more securely engaging a socket to a leverage member may be included along or within the second interface 180.

The second end face 172 includes a third interface 182 that is shaped to fit with a particular type of rotatably fastened object. In the embodiment shown in FIG. 9 and FIG. 10, the third interface 182 is substantially the same shape and size as the first interface 178, but the third interface 182 is raised instead of recessed so that the third interface 182 is capable of engagement with a different type of rotatably fastened object. As with the first interface 178, the third interface 182 is particularly well suited to engage with certain types of drain plugs and clean out plugs. The second end face 172 also includes a fourth interface 184 for removable engagement with a leverage member such as, for example, a ratchet or a breaker bar. In the particular embodiment shown in FIG. 9 and FIG. 10, the fourth interface 184 is shaped in the form of a recessed square, and is preferably substantially identical to the second interface 180.

The dual end structure of the apparatus 166 having two output interfaces (i.e., the first interface 178 and the third interface 182) for engaging two different sized rotatably fastened objects and two input interfaces (i.e., the second interface 180 and the fourth interface 184) for engaging the apparatus 166 with a leverage member minimizes the total number of apparatus that are necessary in a kit of related tools. Additionally, the lateral face 174 with its plurality of sub-faces 176 allows for the apparatus 166 to be engaged along the lateral face 174 by, for example, a human hand, a wrench, or pliers.

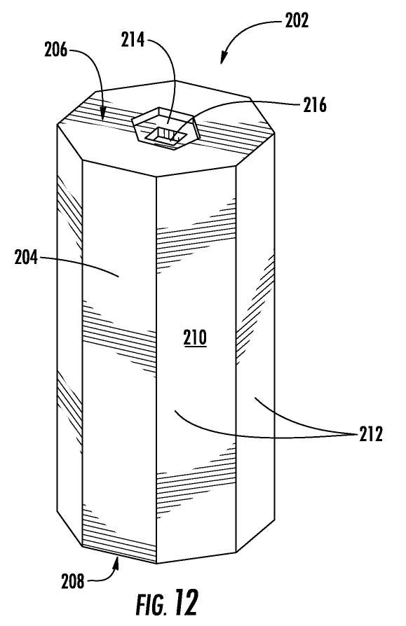

FIG. 11 shows yet another embodiment of an apparatus 186 for removing a rotatably fastened object. The apparatus 186 further includes an elongate member 188, a first end face 190, and a second end face 192. The elongate member 188 further includes a lateral face 194 that, in this embodiment, is further subdivided into a plurality of sub-faces 196.

The first end face 190 includes a first interface 198 that is shaped to fit with a particular type of rotatably fastened object. In the particular embodiment shown in FIG. 11, the first interface 198 is shaped in the form of a recessed square. The first interface 198 is particularly well suited to engage with certain types of drain plugs and clean out plugs. The first end face 190 also includes a second interface 200 for removable engagement with a leverage member such as, for example, a ratcheting socket wrench, a flex bar, and/or a breaker bar. In the particular embodiment shown in FIG. 11, the second interface 180 is shaped in the form of a recessed hexagon to demonstrate that any shape for engaging a socket to a leverage member known to persons having ordinary skill in the art may be used. Moreover, any mechanism known to persons having ordinary skill in the art for more securely engaging a socket to a leverage member may be included along or within the second interface 200.

The second end face 192 includes a third interface (not shown) that is shaped to fit with a particular type of rotatably fastened object. The second end face 192 also includes a fourth interface (not shown) for removable engagement with a leverage member such as, for example, a ratchet or a breaker bar.

The dual end structure of the apparatus 166 having two output interfaces (i.e., the first interface 198 and the third interface (not shown)) for engaging two different sized rotatably fastened objects and two input interfaces (i.e., the second interface 200 and the fourth interface (not shown)) for engaging the apparatus 186 with a leverage member minimizes the total number of apparatus that are necessary in a kit of related tools. Additionally, the lateral face 194 with its plurality of sub-faces 196 allows for the apparatus 186 to be engaged along the lateral face 194 by, for example, a human hand, a wrench, or pliers.

FIG. 12 shows another embodiment of an apparatus 202 for removing a rotatably fastened object. The apparatus 202 further includes an elongate member 204, a first end face 206, and a second end face 208. The elongate member 204 further includes a lateral face 210 that, in this embodiment, is further subdivided into a plurality of sub-faces 212.

The first end face 206 includes a first interface 214 that is shaped to fit with a particular type of rotatably fastened object. In the particular embodiment shown in FIG. 12, the first interface 214 is shaped in the form of a recessed hexagon. This embodiment (apparatus 202) demonstrates that various shapes including various polygonal structures (raised or recessed and of varying sizes) may be used in alternative embodiments of apparatus (10, 28, 46, 66, 86, 106, 126, 146, 166, and 186) and other alternative embodiments. The first end face 206 also includes a second interface 216 for removable engagement with a leverage member such as, for example, a ratcheting socket wrench, a flex handle, and/or a breaker bar. In the particular embodiment shown in FIG. 12, the second interface 216 is shaped in the form of a recessed square. However, any shape for engaging a socket to a leverage member known to persons having ordinary skill in the art may be used. Moreover, any mechanism known to persons having ordinary skill in the art for more securely engaging a socket to a leverage member may be included along or within the second interface 216.

The second end face 208 includes a third interface (not shown) that is shaped to fit with a particular type of rotatably fastened object. The second end face 208 also includes a fourth interface (not shown) for removable engagement with a leverage member such as, for example, a ratchet or a breaker bar.

The dual end structure of the apparatus 202 having two output interfaces (i.e., the first interface 214 and the third interface (not shown)) for engaging two different sized rotatably fastened objects and two input interfaces (i.e., the second interface 216 and the fourth interface (not shown)) for engaging the apparatus 202 with a leverage member minimizes the total number of apparatus that are necessary in a kit of related tools. Additionally, the lateral face 210 with its plurality of sub-faces 212 allows for the apparatus 202 to be engaged along the lateral face 210 by, for example, a human hand, a wrench, or pliers.

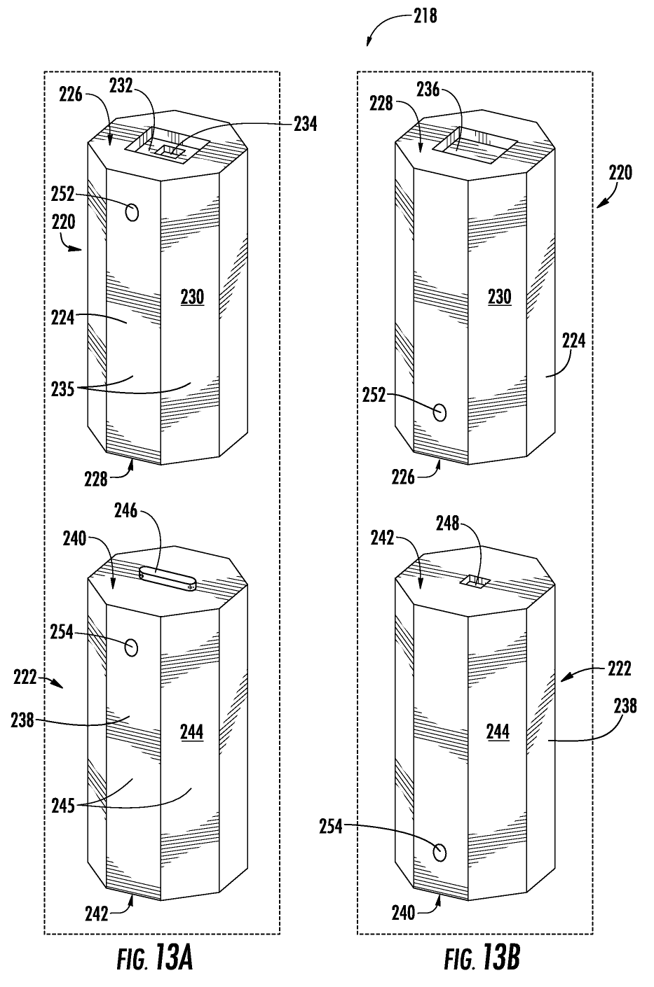

FIG. 13 shows an embodiment of a kit 218 for removing rotatably fastened objects. The kit includes a first apparatus 220 for removing a first type of rotatably fastened object and a second apparatus 222 for removing a second type of rotatable fastened object. Two separate views of each apparatus (220 and 222) are shown adjacent to one another with a first view of each apparatus (220 and 222) in Column A and a second view of each apparatus (220 and 222) in Column B.

The first apparatus 220 includes an elongate member 224, a first end face 226, and a second end face 228. The elongate member 234 further includes a lateral face 230 that, in this embodiment, is further subdivided into a plurality of sub-faces 235. The first end face 226 includes a first interface 232 that is shaped to fit with a particular type of rotatably fastened object. In the particular embodiment shown in FIG. 13, the first interface 232 is shaped in the form of a recessed square. The first end face 226 also includes a second interface 234 for removable engagement with a leverage member such as, for example, a ratcheting wrench, a flex bar, and/or a breaker bar. In the particular embodiment shown in FIG. 13, the second interface 234 is shaped in the form of a recessed square. However, any shape for engaging a socket to a leverage member known to persons having ordinary skill in the art may be used. Moreover, any mechanism known to those skilled in the art for more securely engaging a socket to a leverage member may be included along or within the second interface 232. The second end face 228 includes a third interface 236 that is shaped to fit with a particular type of rotatably fastened object. In the embodiment shown in FIG. 13, the third interface 236 is substantially the same shape as the first interface 232, but the third interface 236 is sized smaller so that the third interface 236 is capable of engagement with a different sized rotatably fastened object. As with the first interface 232, the third interface 236 is particularly well suited to engage with certain types of drain plugs and clean out plugs.

The second apparatus 222 includes an elongate member 238, a first end face 240, and a second end face 242. The elongate member 238 further includes a lateral face 244 that, in this embodiment, is further subdivided into a plurality of sub-faces 245. The first end face 240 includes a first interface 246 that is shaped to fit with a particular type of rotatably fastened object. In the particular embodiment shown in FIG. 13, the first interface 246 is shaped in the form of a raised elongate block. The second end face 242 includes a second interface 248 for removable engagement with a leverage member such as, for example, a ratcheting socket wrench, a flex bar, and/or a breaker bar. In the particular embodiment shown in FIG. 13, the second interface 248 is shaped in the form of a recessed square. However, any shape for engaging a socket to a leverage member known to persons having ordinary skill in the art may be used. Moreover, any mechanism known to persons having ordinary skill in the art for more securely engaging a socket to a leverage member may be included along or within the second interface 248.

In the embodiment shown in FIG. 13, the first apparatus 220 includes an orifice 252 that extends through a portion of the first apparatus 220. The second apparatus 222 also includes an orifice 254 that extends through a portion of the second apparatus 222. This allows at least two members of kit 218 to be connected to one another by, for example, placing a connector through orifice 250 and orifice 252. Examples of connectors could include, for example, a string, a wire, a rod or other connector known to persons having ordinary skill in the art that could extend through orifice 250 and orifice 252.

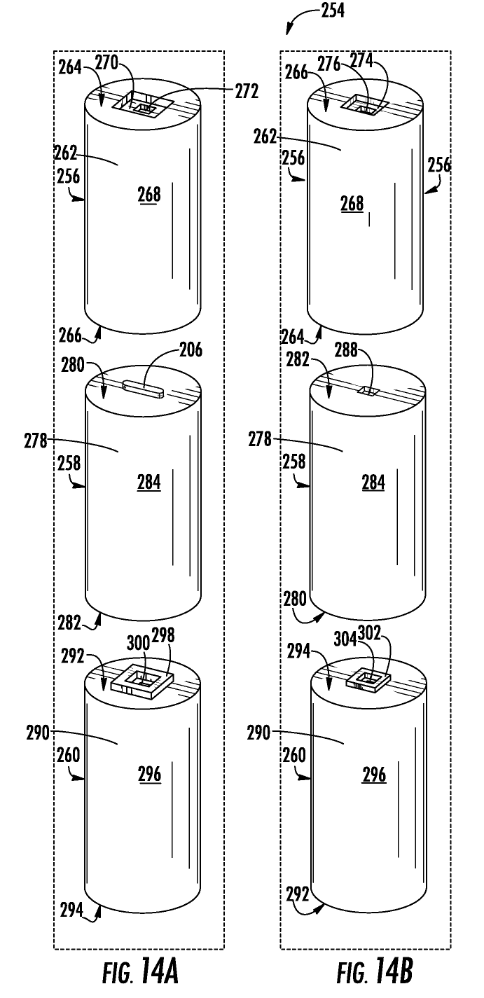

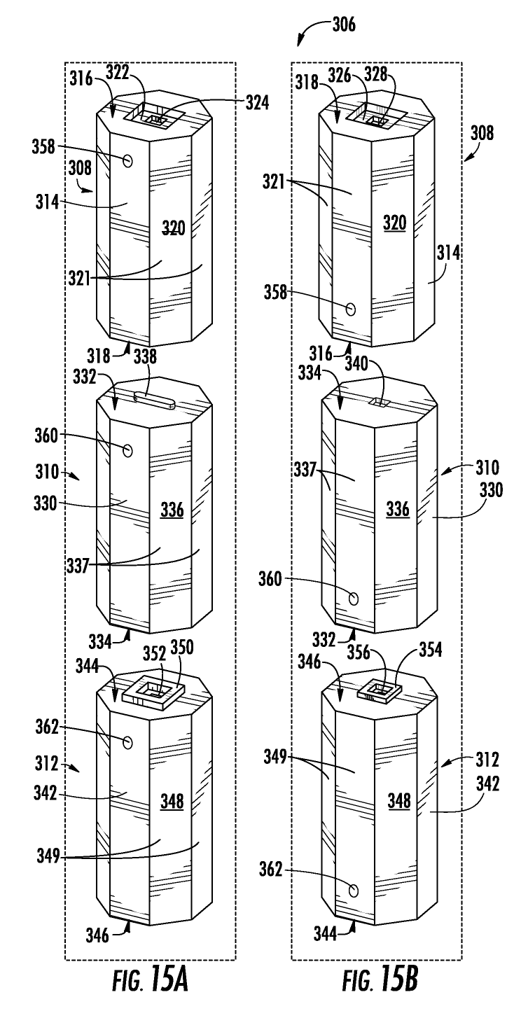

FIG. 14 shows an embodiment of a kit 254 for removing rotatably fastened objects. The kit includes a first apparatus 256 for removing a first type of rotatably fastened object, a second apparatus 258 for removing a second type of rotatable fastened object, and a third apparatus 260 for removing a third type of rotatable fastened object. Two separate views of each apparatus (256, 258, and 260) are shown adjacent to one another with a first view of each apparatus (256, 258, and 260) in Column A and a second view of each apparatus (256, 258, and 260) in Column B.

The first apparatus 256 includes an elongate member 262, a first end face 264, and a second end face 266. The elongate member 262 further includes a lateral face 268. The first end face 264 includes a first interface 270 that is shaped to fit with a particular type of rotatably fastened object. In the particular embodiment shown in FIG. 14, the first interface 270 is shaped in the form of a recessed square. The first end face 264 also includes a second interface 272 for removable engagement with a leverage member such as, for example, a ratcheting socket wrench, a flex bar, and/or a breaker bar. In the particular embodiment shown in FIG. 14, the second interface 272 is shaped in the form of a recessed square. However, any shape for engaging a socket to a leverage member known to persons having ordinary skill in the art may be used. Moreover, any mechanism known to persons having ordinary skill in the art for more securely engaging a socket to a leverage member may be included along or within the second interface 272. The second end face 266 includes a third interface 274 that is shaped to fit with a particular type of rotatably fastened object. In the embodiment shown in FIG. 14, the third interface 274 is substantially the same shape as the first interface 270, but the third interface 274 is sized smaller so that the third interface 274 is capable of engagement with a different sized rotatably fastened object. As with the first interface 270, the third interface 274 is particularly well suited to engage with certain types of drain plugs and clean out plugs. The second end face 266 also includes a fourth interface 276 for removable engagement with a leverage member such as, for example, a ratcheting socket wrench, a flex bar, and/or a breaker bar. In the particular embodiment shown in FIG. 14, the fourth interface 276 is shaped in the form of a recessed square, and is preferably substantially identical to the second interface 272.

The second apparatus 258 includes an elongate member 278, a first end face 280, and a second end face 282. The elongate member 278 further includes a lateral face 284. The first end face 280 includes a first interface 286 that is shaped to fit with a particular type of rotatably fastened object. In the particular embodiment shown in FIG. 14, the first interface 286 is shaped in the form of a raised elongate block. The second end face 282 includes a second interface 288 for removable engagement with a leverage member such as, for example, a ratcheting socket wrench, a flex bar, and/or a breaker bar. In the particular embodiment shown in FIG. 14, the second interface 288 is shaped in the form of a recessed square. However, any shape for engaging a socket to a leverage member known to persons having ordinary skill in the art may be used. Moreover, any mechanism known to persons having ordinary skill in the art for more securely engaging a socket to a leverage member may be included along or within the second interface 288.

The third apparatus 260 includes an elongate member 290, a first end face 292, and a second end face 294. The elongate member 290 further includes a lateral face 296. The first end face 292 includes a first interface 298 that is shaped to fit with a particular type of rotatably fastened object. In the particular embodiment shown in FIG. 14, the first interface 298 is shaped in the form of a raised square. The first end face 292 also includes a second interface 300 for removable engagement with a leverage member such as, for example, a ratcheting socket wrench, a flex handle, and/or a breaker bar. In the particular embodiment shown in FIG. 14, the second interface 300 is shaped in the form of a recessed square. However, any shape for engaging a socket to a leverage member known to persons having ordinary skill in the art may be used. Moreover, any mechanism known to persons having ordinary skill in the art for more securely engaging a socket to a leverage member may be included along or within the second interface 300. The second end face 294 includes a third interface 302 that is shaped to fit with a particular type of rotatably fastened object. In the embodiment shown in FIG. 14, the third interface 302 is substantially the same shape as the first interface 298, but the third interface 302 is sized smaller so that the third interface 302 is capable of engagement with a different sized rotatably fastened object. As with the first interface 298, the third interface 302 is particularly well suited to engage with certain types of drain plugs and clean out plugs. The second end face 294 also includes a fourth interface 304 for removable engagement with a leverage member such as, for example, a ratcheting socket wrench, a flex bar, and/or a breaker bar. In the particular embodiment shown in FIG. 14, the fourth interface 304 is shaped in the form of a recessed square, and is preferably substantially identical to the second interface 300.

FIG. 15 shows an embodiment of a kit 306 for removing rotatably fastened objects. The kit includes a first apparatus 308 for removing a first type of rotatably fastened object, a second apparatus 310 for removing a second type of rotatable fastened object, and a third apparatus 312 for removing a third type of rotatable fastened object. Two separate views of each apparatus (308, 310, and 312) are shown adjacent to one another with a first view of each apparatus (308, 310, and 312) in Column A and a second view of each apparatus (308, 310, and 312) in Column B.

The first apparatus 308 includes an elongate member 314, a first end face 316, and a second end face 318. The elongate member 314 further includes a lateral face 320 that, in this embodiment, is further subdivided into a plurality of sub-faces 321. The first end face 316 includes a first interface 322 that is shaped to fit with a particular type of rotatably fastened object. In the particular embodiment shown in FIG. 15, the first interface 322 is shaped in the form of a recessed square. The first end face 316 also includes a second interface 324 for removable engagement with a leverage member such as, for example, a ratcheting socket wrench, a flex bar, and/or a breaker bar. In the particular embodiment shown in FIG. 15, the second interface 324 is shaped in the form of a recessed square. However, any shape for engaging a socket to a leverage member known to persons having ordinary skill in the art may be used. Moreover, any mechanism known to persons having ordinary skill in the art for more securely engaging a socket to a leverage member may be included along or within the second interface 324. The second end face 318 includes a third interface 326 that is shaped to fit with a particular type of rotatably fastened object. In the embodiment shown in FIG. 15, the third interface 326 is substantially the same shape as the first interface 322, but the third interface 326 is sized smaller so that the third interface 326 is capable of engagement with a different sized rotatably fastened object. As with the first interface 322, the third interface 326 is particularly well suited to engage with certain types of drain plugs and clean out plugs. The second end face 318 also includes a fourth interface 328 for removable engagement with a leverage member such as, for example, a ratcheting socket wrench, a flex bar, and/or a breaker bar. In the particular embodiment shown in FIG. 15, the fourth interface 328 is shaped in the form of a recessed square, and is preferably substantially identical to the second interface 324.

The second apparatus 310 includes an elongate member 330, a first end face 332, and a second end face 334. The elongate member 330 further includes a lateral face 336 that, in this embodiment, is further subdivided into a plurality of sub-faces 337. The first end face 332 includes a first interface 338 that is shaped to fit with a particular type of rotatably fastened object. In the particular embodiment shown in FIG. 15, the first interface 338 is shaped in the form of a raised elongate block. The second end face 334 includes a second interface 340 for removable engagement with a leverage member such as, for example, a ratcheting socket wrench, a flex bar, and/or a breaker bar. In the particular embodiment shown in FIG. 15, the second interface 340 is shaped in the form of a recessed square. However, any shape for engaging a socket to a leverage member known to persons having ordinary skill in the art may be used. Moreover, any mechanism known to persons having ordinary skill in the art for more securely engaging a socket to a leverage member may be included along or within the second interface 340.

The third apparatus 312 includes an elongate member 342, a first end face 344, and a second end face 346. The elongate member 342 further includes a lateral face 348 that, in this embodiment, is further subdivided into a plurality of sub-faces 349. The first end face 344 includes a first interface 350 that is shaped to fit with a particular type of rotatably fastened object. In the particular embodiment shown in FIG. 15, the first interface 350 is shaped in the form of a raised square. The first end face 344 also includes a second interface 352 for removable engagement with a leverage member such as, for example, a ratcheting socket wrench, a flex bar, and/or a breaker bar. In the particular embodiment shown in FIG. 15, the second interface 352 is shaped in the form of a recessed square. However, any shape for engaging a socket to a leverage member known to persons having ordinary skill in the art may be used. Moreover, any mechanism known to persons having ordinary skill in the art for more securely engaging a socket to a leverage member may be included along or within the second interface 352. The second end face 346 includes a third interface 354 that is shaped to fit with a particular type of rotatably fastened object. In the embodiment shown in FIG. 15, the third interface 354 is substantially the same shape as the first interface 350, but the third interface 354 is sized smaller so that the third interface 354 is capable of engagement with a different sized rotatably fastened object. As with the first interface 350, the third interface 354 is particularly well suited to engage with certain types of drain plugs and clean out plugs. The second end face 346 also includes a fourth interface 356 for removable engagement with a leverage member such as, for example, a ratcheting socket wrench, a flex handle, and/or a breaker bar. In the particular embodiment shown in FIG. 15, the fourth interface 356 is shaped in the form of a recessed square, and is preferably substantially identical to the second interface 352.

In the embodiment shown in FIG. 15, the first apparatus 308 includes an orifice 358 that extends through a portion of the first apparatus 308. The second apparatus 310 includes an orifice 360 that extends through a portion of the second apparatus 310. The third apparatus 312 includes an orifice 362 that extends through a portion of the third apparatus 312. These orifices (358, 360, and 362) allow at least three members of kit 306 to be connected to one another by, for example, placing a connector through orifice 358, orifice 360, and orifice 362. Examples of connectors could include, for example, a string, a wire, a rod or other connector known to persons having ordinary skill in the art that could extend through the orifices (358, 360, and 362).

The various embodiments of apparatus described above individually (10, 28, 46, 66, 86, 106, 126, 146, 166, 186, and 202) or as members of a kit (220, 222, 256, 258, 260, 308, 310, and 312) are preferably made from a hard material such as aluminum, stainless steel, or other high tensile strength metal alloy. It should be understood, however, that the various apparatus described herein and their equivalents may be made from any high tensile strength material or other suitable material known to persons having ordinary skill in the art. The various embodiments of apparatus (10, 28, 46, 66, 86, 106, 126, 146, 166, 186, 202, 220, 222, 256, 258, 260, 308, 310, and 312) and equivalents thereof preferably have a length ranging from about 4 inches to about 10 inches, and more preferably from about 6 inches to about 8 inches. The square output shapes described above with regard to apparatus (10, 28, 46, 66, 86, 106, 126, 146, 166, 186, 220, 256, 260, 308, and 312), whether raised or recessed, preferably come in sizes ranging from a square side length of about 0.5 inches to about 3 inches, and more preferably from about 1 inch to about 1.5 inches. However, other non-traditional output shape sizes are contemplated by the various embodiments described herein. All of the output shapes described above, whether raised or recessed, preferably have a depth or height ranging from about 0.2 inches to about 1 inch, and more preferably have a depth or height ranging from about 0.4 inches to about 0.8 inches.

The foregoing description of preferred embodiments for this invention have been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. An apparatus for removing a rotatably fastened object, the apparatus comprising a multifaceted elongate member, wherein the elongate member includes:
a. an elongate lateral face, the elongate lateral face including a plurality of sub-faces, wherein at least two of the sub-faces are substantially planar and extend substantially the entire length of the elongate member;
b. a first end face, wherein the first end face includes a first interface to substantially engage the elongate member with a rotatably fastened object so that a rotational force is applied to the fastened object substantially when a force is applied to the elongate member, and wherein the first end face also includes a second interface to substantially engage the elongate member with a leverage tool; and
c. a second end face, wherein the second end face includes a third interface to substantially engage the elongate member with a rotatably fastened object so that a rotational force is applied to the fastened object substantially when a force is applied to the elongate member, and wherein the second end face also includes a fourth interface to substantially engage the elongate member with a leverage tool.

2-3. (canceled)

4. The elongate member of claim 1 wherein the first interface comprises a first engagement profile and the second interface comprises a second engagement profile, wherein the shape of the first engagement profile is substantially identical to the shape of the second engagement profile, but wherein the first engagement profile differs in size from the second engagement profile.

5. The elongate member of claim 1 wherein the first interface comprises a first engagement profile and the second interface comprises a second engagement profile, wherein the shape of the first engagement profile differs from the shape of the second engagement profile, but wherein the size of the first engagement profile directly corresponds to the size of the second engagement profile.

6. (canceled)

7. The elongate member of claim 1 wherein the first interface comprises a first output shape for engagement with a rotatably fastened object, the first output shape being selected from the group consisting of a recessed polygon and a raised polygon; and wherein the third interface comprises a second output shape for engagement with a rotatably fastened object, the second output shape being selected from the group consisting of a recessed polygon and a raised polygon.

8. The elongate member of claim 5 wherein the first interface comprises a first output shape for engagement with a rotatably fastened object, the first output shape being selected from the group consisting of a recessed polygon and a raised polygon; and wherein the third interface comprises a second output shape for engagement with a rotatably fastened object, the second output shape being selected from the group consisting of a recessed polygon and a raised polygon.

9. The elongate member of claim 7 wherein the second interface comprises a first input shape for engagement with a leverage tool, wherein the first input shape includes a recessed polygon; and wherein the fourth interface comprises a second input shape for engagement with a leverage tool, wherein the second input shape includes a recessed polygon.

10. The elongate member of claim 8 wherein the second interface comprises a first input shape for engagement with a leverage tool, wherein the first input shape includes a recessed polygon; and wherein the fourth interface comprises a second input shape for engagement with a leverage tool, wherein the second input shape includes a recessed polygon.

11-12. (canceled)

13. A kit for removing rotatably fastened objects, the kit comprising:
a. a first elongate member, wherein the first elongate member includes:
i. a first elongate lateral face including a plurality of sub-faces, wherein at least two of the sub-faces are substantially planar and extend substantially the entire length of the first elongate member;
ii. a first end face, wherein the first end face includes a first interface to substantially engage the first elongate member with a rotatably fastened object so that a rotational force is applied to the fastened object substantially when a force is applied to the first elongate member, and wherein the first end face also includes a second interface to substantially engage the first elongate member with a leverage tool; and
iii. a second end face, wherein the second end face includes a third interface to substantially engage the first elongate member with a rotatably fastened object so that a rotational force is applied to the fastened object substantially when a force is applied to the first elongate member, and wherein the second end face also includes a fourth interface to substantially engage the first elongate member with a leverage tool; and
b. a second elongate member, wherein the second elongate member includes:
i. a second elongate lateral face including a plurality of sub-faces, wherein at least two of the sub-faces are substantially planar and extend substantially the entire length of the second elongate member;
ii. a third end face, wherein the third end face includes a fifth interface to substantially engage the second elongate member with a rotatably fastened object so that a rotational force is applied to the fastened object substantially when a force is applied to the second elongate member; and
iii. a fourth end face, wherein the fourth end face includes a sixth interface to substantially engage the second elongate member with a leverage tool.

14. (canceled)

15. The kit of claim 13 wherein the first elongate member includes a first orifice located alone the first lateral face and wherein the second elongate member includes a second orifice located along the second lateral face, whereby the first elongate member may be connected to the second elongate member by placing a connector through the first orifice and through the second orifice.

16. (canceled)

17. The kit of claim 13 further comprising a third elongate member, the third elongate member including:
a. a third elongate lateral face including a plurality of sub-faces, wherein at least two of the sub-faces are substantially planar and extend substantially the entire length of the third elongate member;
b. a fifth end face, wherein the fifth end face includes a seventh interface to substantially engage the third elongate member with a rotatably fastened object so that a rotational force is applied to the fastened object substantially when a force is applied to the third elongate member, and wherein the fifth end face includes an eighth interface to substantially engage the third elongate member with a leverage tool; and
c. a sixth end face, wherein the sixth end face includes a ninth interface to substantially engage the third elongate member with a rotatably fastened object so that a rotational force is applied to the fastened object substantially when a force is applied to the third elongate member, and wherein the sixth end face includes a tenth interface to substantially engage the third elongate member with a leverage tool.

18. The kit of claim 17 wherein the first elongate member includes a first orifice, wherein the second elongate member includes a second orifice, and wherein the third elongate member includes a third orifice, whereby the first elongate member, the second elongate member, and the third elongate member may be connected to one another by placing a connector through the first orifice, through the second orifice, and through the third orifice.

19. The kit of claim 17 wherein:
a. the first interface includes a first output shape for engagement with a rotatably fastened object, the first output shape being selected from the group consisting of a recessed polygon and a raised polygon; wherein the second interface includes a first input shape for engagement with a leverage tool, the first input shape including a recessed polygon; wherein the third interface includes a second output shape for engagement with a rotatably fastened object, the second output shape being selected from the group consisting of a recessed polygon and a raised polygon; and wherein the fourth interface includes a first input shape for engagement with a leverage tool, the first input shape including a recessed polygon;
b. the fifth interface includes a third output shape for engagement with a rotatably fastened object, the third output shape being selected from the group consisting of a recessed polygon, a raised polygon, and a raised elongate block; wherein the sixth interface includes a third input shape for engagement with a leverage tool, the second input shape including a recessed polygon; and
c. the seventh interface includes a fourth output shape for engagement with a rotatably fastened object, the fourth output shape being selected from the group consisting of a recessed polygon and a raised polygon; wherein the eighth interface includes a fourth input shape for engagement with a leverage tool, the fourth input shape including a recessed polygon; wherein the ninth interface includes a fifth output shape for engagement with a rotatably fastened object, the fifth output shape being selected from the group consisting of a recessed polygon and a raised polygon; and wherein the tenth interface includes a fifth input shape for engagement with a leverage tool, the fifth input shape including a recessed polygon.

20. A kit for removing rotatably fastened objects, the kit comprising:
a. a first elongate member, wherein the first elongate member includes a length ranging from about two inches to about ten inches, and wherein the first elongate member further includes:
i. a first elongate lateral face;
ii. a first end face, wherein the first end face includes a first interface to substantially engage the first elongate member with a rotatably fastened object so that a rotational force is applied to the fastened object substantially when a force is applied to the first elongate member, and wherein the first end face also includes a second interface to substantially engage the first elongate member with a leverage tool; and
iii. a second end face, wherein the second end face includes a third interface to substantially engage the first elongate member with a rotatably fastened object so that a rotational force is applied to the fastened object substantially when a force is applied to the first elongate member, and wherein the first end face also includes a fourth interface to substantially engage the first elongate member with a leverage tool;
b. a second elongate member, wherein the second elongate member includes a length ranging from about two inches to about ten inches, and wherein the second elongate member further includes:
i. a second elongate lateral face;
ii. a third end face, wherein the third end face includes a fifth interface to substantially engage the second elongate member with a rotatably fastened object so that a rotational force is applied to the fastened object substantially when a force is applied to the second elongate member, and wherein the third end face also includes a sixth interface to substantially engage the second elongate member with a leverage tool; and
iii. a fourth end face, wherein the fourth end face includes a seventh interface to substantially engage the second elongate member with a rotatably fastened object so that a rotational force is applied to the fastened object substantially when a force is applied to the second elongate member, and wherein the third end face also includes an eighth interface to substantially engage the second elongate member with a leverage tool; and
c. a third elongate member, wherein the third elongate member includes a length ranging from about two inches to about ten inches, wherein the first elongate member includes a first orifice, wherein the second elongate member includes a second orifice, and wherein the third elongate member includes a third orifice, whereby the first elongate member, the second elongate member, and the third elongate member may be connected to one another by placing a connector through the first orifice, through the second orifice, and through the third orifice, and wherein the third elongate member further includes:
i. a third elongate lateral face, wherein at least one of the first elongate lateral face, the second elongate lateral face, and the third elongate lateral face comprises a plurality of sub-faces, and wherein at least two of the sub-faces are substantially planar;
ii. a fifth end face, wherein the fifth end face includes a ninth interface to substantially engage the third elongate member with a rotatably fastened object so that a rotational force is applied to the fastened object substantially when a force is applied to the third elongate member; and
iii. a sixth end face, wherein the sixth end face includes a tenth interface to substantially engage the third elongate member with a leverage tool.

21. The apparatus for removing a rotatably fastened object of claim 5 wherein the elongate member has a length ranging from about four inches to about ten inches.

22. The apparatus for removing a rotatably fastened object of claim 7 wherein the elongate lateral face further comprises two substantially planar and substantially parallel sub-faces and at least two curved sub-faces.

23. The apparatus for removing a rotatably fastened object of claim 8 wherein the elongate lateral face further comprises two substantially planar and substantially parallel sub-faces and at least two curved sub-faces.
